(19) United States
(12) Patent Application Publication
(10) Pub. No.: US 2010/0182745 A1
(43) Pub. Date: Jul. 22, 2010

(54) Thin notebook computer

(75) Inventor: Gwo-Chyuan Chen, Taipei City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/385,239

(22) Filed: Apr. 2, 2009

(30) Foreign Application Priority Data
Jan. 21, 2009 (TW) 98201187

(51) Int. Cl. G06F 1/16

(52) U.S. Cl. 361/679.55

(57) ABSTRACT

A thin notebook computer is disclosed, which includes a first casing, a LCD panel disposed in the first casing, a second casing, a hinge for connecting the first casing and the second casing, a battery, and a keyboard. The battery and the keyboard are disposed in the second casing. The battery is disposed on one side of the keyboard and is not arranged under the keyboard.

### RELATED APPLICATIONS

This application claims priority to Taiwan Application Serial Number 98201187, filed Jan. 21, 2009, which is herein incorporated by reference.

### BACKGROUND

1. Field of Invention

The present invention relates to a portable electronic device. More particularly, the present invention relates to a notebook computer.

2. Description of Related Art

Due to rapid the development in electrical technologies and portable computer applications, notebook computers are gradually becoming smaller and lighter with each passing day. Notebooks with a portable outline size and weight create an enormous increase in processing speed, and therefore notebook computers have become popular electronic products.

Refer to FIG. 1. FIG. 1 illustrates a conventional system stack arrangement of a notebook computer. The notebook computer 100 includes liquid crystal display (LCD) panel 110, a keyboard 120, a battery 130, a printed circuit board 140, and a connection port 150. The size of the LCD panel 110 determines the size of the notebook computer 100. The system stack arrangement determines the thickness of the notebook computer 100.

For example, the keyboard 120 is disposed under the LCD panel 110 in FIG. 1. The battery 130 and the printed circuit board 140 are disposed under the keyboard 120. The connection port 150 is also disposed under the keyboard 120.

The system stack arrangement disclosed in FIG. 1 is widely used in conventional notebook computers. The system stack arrangement determines the thickness of the notebook computer. However, the conventional system stack arrangement, i.e. the keyboard is disposed under the LCD panel, and the battery, the printed circuit board, and the connection port are further disposed under the keyboard, makes reducing the thickness of the notebook computer difficult.

### SUMMARY

The embodiment of the invention provides a thin notebook computer, which includes a first casing, a LCD panel disposed in the first casing, a second casing, a hinge for connecting the first casing and the second casing, a battery, and a keyboard. The battery and the keyboard are disposed in the second casing. The battery is disposed on one side of the keyboard and is not arranged under the keyboard.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a conventional system stack arrangement of a notebook computer;

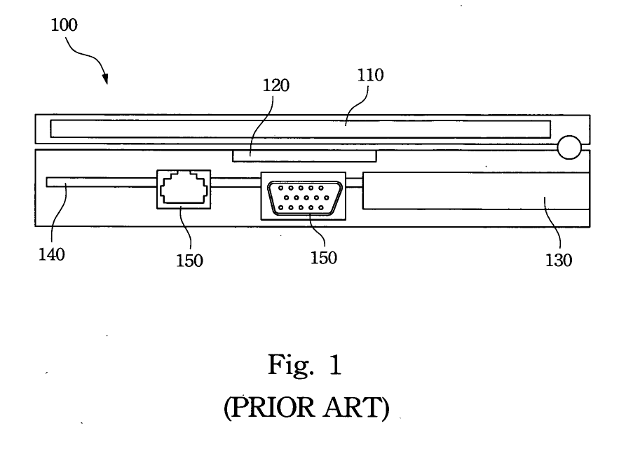

FIG. 2 illustrates a top view diagram and a side view diagram of a first embodiment of the thin notebook computer of the invention; and

FIG. 3 illustrates a front view diagram and a side view diagram of a second embodiment of the thin notebook computer of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

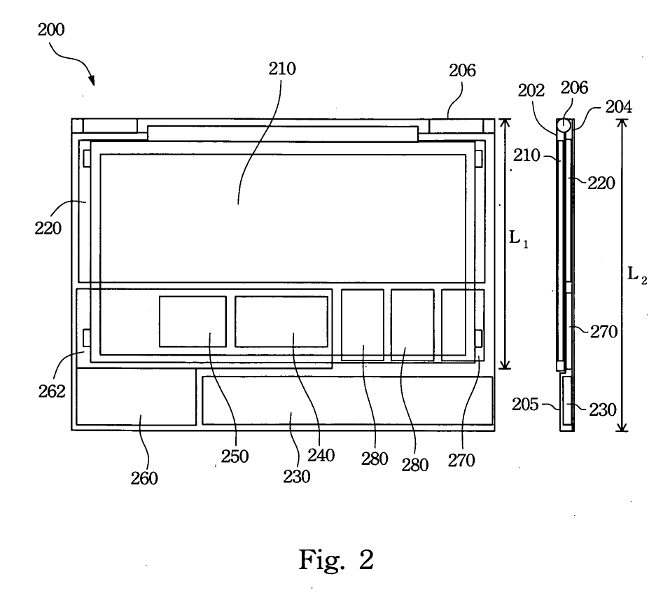

Refer to FIG. 2. FIG. 2 illustrates a front view diagram and a side view diagram of a first embodiment of the thin notebook computer of the invention. The thin notebook computer 200 includes a first casing 202, a second casing 204, and a hinge 206 for connecting the first casing 202 and the second casing 204. The thin notebook computer 200 includes a liquid crystal display panel 210 disposed in the first casing 202. The thin notebook computer 200 includes a keyboard 220 and a battery 230 disposed in the second casing 204. The battery 230 is arranged on the side of the keyboard 220. The battery 230 is not arranged under the keyboard 220.

The battery 230 does not overlap the liquid crystal display panel 210. Namely the battery 230 is not placed under the LCD panel 210 on one side view when the thin notebook computer 200 is closed.

The battery 230 can be a thin battery. The battery 230 in this embodiment is placed on the front side of the second casing 204. The thin notebook computer 200 includes a touch pad 240. The touch pad 240 and the battery 230 are disposed on the same side of the keyboard 220. The touch pad 240 is disposed between the keyboard 220 and the battery 230. The length L₂ of the second casing 204 is larger than the length L₁ of the first casing 202.

The battery 230 can be regarded as the thickest component in the thin Is notebook computer 200, and the position of the battery 230 can determined the thickness of the thin notebook computer 200. The second casing 204 in this embodiment has a protruding portion 205 for providing a space to locate the battery 230. The battery 230 is disposed in the protruding potion 205 of the second casing 204. The protruding portion 205 and the battery 230 within are arranged outside of the LCD panel 210. The protruding portion 205 does not overlap the first casing 202. The protruding portion 205 can be arranged at the front side of the second casing 204 in this embodiment. The protruding portion 205 at the front side of the thin notebook computer 200 can support the wrist of the user.

The thin notebook computer 200 further includes other components such as a fan 250, several printed circuit boards 260 and 262, a hard disk 270, several mini cards 280, etc. The components are disposed in the second casing 204. The printed circuit board 260 is arranged next to the battery 230 and does not overlap the LCD panel 210. The printed circuit board 262 is disposed on one side of the touch pad 240. The printed circuit board 262 is disposed mainly under the LCD panel 210. The hard disk 270 and the fan 250 are disposed in the space between the keyboard 220 and the battery 230. The hard disk 270 and the fan 250 are not disposed under the keyboard 220. The hard disk 270 and the fan 250 are arranged at two opposite sides of the touch pad 240 respectively in this embodiment. The fan 250 is disposed on the printed circuit board 262. The mini cards 280 are disposed between the hard disk 270 and the touch pad 240.

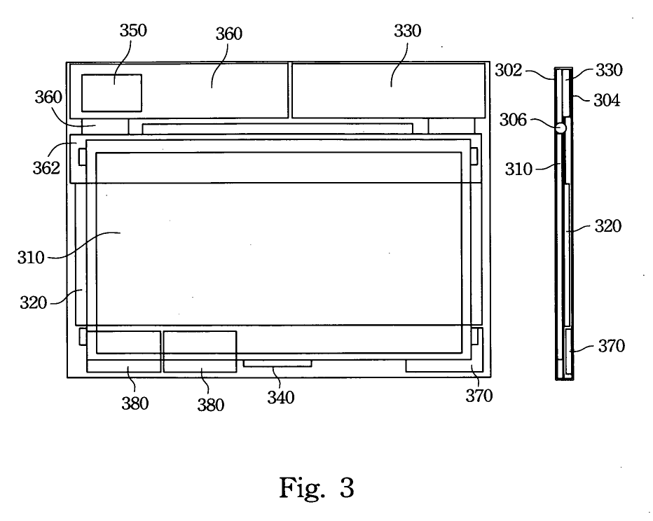

Refer to FIG. 3. FIG. 3 illustrates a front view diagram and a side view diagram of a second embodiment of the thin notebook computer of the invention. The thin notebook computer 300 includes a first casing 302, a second casing 304, and a hinge 306 for connecting the first casing 302 and the second casing 304. The thin notebook computer 300 includes a liquid crystal display panel 310 disposed in the first casing 302. The thin notebook computer 300 includes a keyboard 320 and a battery 330 disposed in the second casing 304. The battery 330 is arranged on one side of the keyboard 320. The battery 330 is not arranged under the keyboard 320.

The battery 330 does not overlap the liquid crystal display panel 310 when the thin notebook computer 300 is not in use. Namely the battery 330 is not arranged under the LCD panel 310 on one side view when the first casing 302 is not lifted from the second casing 304.

The battery 330 is a thin battery. The battery 330 is arranged at a back side of the second casing 304. The thin notebook computer 300 includes a touch pad 340. The touch pad 340 and the battery 330 are disposed at two opposite sides of the keyboard 320. The touch pad 340 is arranged at a front side of the second casing 304. The battery 330 is arranged in the second casing 304 and outside of the hinge 306.

The thin notebook computer 300 includes other components such as a fan 350, several printed circuit boards 360 and 362, a hard disk 370, several mini cards 380, etc. The components can be disposed in the second casing 304. The printed circuit board 360 and the fan 350 are disposed at the same side of the keyboard 320. The fan 350 is disposed on the printed circuit board 360. The printed circuit board 362 is disposed between the battery 330 and the keyboard 320. The printed circuit board 362 is disposed mainly under the LCD panel 310. The hard disk 370 and the mini cards 380 are disposed at two opposite sides of the touch pad 340 in this embodiment.

The battery is arranged on one side of the keyboard in the present embodiments. The battery is arranged at the front side or the back side in the second casing and does not overlap the LCD panel. The battery is not arranged under the keyboard, thus the thickness of the thin notebook computer can be reduced. The second casing may have the protruding portion at the front when the battery is arranged at the front side in the second casing. The protruding portion at the front of the second casing can support user's wrist.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin notebook computer comprising:
a first casing;
a liquid crystal display panel disposed in the first casing;
a second casing;
a hinge connecting the first casing and the second casing;
a keyboard disposed in the second casing; and
a battery disposed in the second casing and arranged on one side of the keyboard, wherein the battery is not disposed under the keyboard.

2. The thin notebook computer of claim 1, wherein the battery is a thin battery.

3. The thin notebook computer of claim 1, further comprising a touch pad disposed outside of the keyboard.

4. The thin notebook computer of claim 3, wherein the touch pad does not overlap the battery.

5. The thin notebook computer of claim 4, wherein the touch pad and the battery are arranged at different sides of the keyboard respectively.

6. The thin notebook computer of claim 5, wherein the battery is disposed at a back side, in the second casing, and the hinge is disposed between the battery and the keyboard in the second casing.

7. The thin notebook computer of claim 4, wherein the battery is disposed at a front side in the second casing, and the touch pad and the battery are arranged at the same side of the keyboard.

8. The thin notebook computer of claim 7, wherein the touch pad is arranged between the keyboard and the battery.

9. The thin notebook computer of claim 8, wherein the second casing has a protruding portion disposed corresponding the battery and arranged outside of the liquid crystal display panel.

10. The thin notebook computer of claim 1, wherein the battery does not overlap the liquid crystal display panel.
